(19) United States
(12) Patent Application Publication
(10) Pub. No.: US 2001/0039618 A1
(43) Pub. Date: Nov. 8, 2001

(54) User authentication method, network system used for same and storage medium storing control program of same

(76) Inventor: Tomihiko Azuma, Tokyo (JP)

Correspondence Address: SUGHRUE, MION, ZINN, MACPEAK & SEAS, 2100 Pennsylvania Avenue, N.W., Washington, DC, 20037-3202, US

(21) Appl. No.: 09/845,319

(22) Filed: May 1, 2001

(30) Foreign Application Priority Data
May 2, 2000 (JP) 134054/2000

(51) Int. Cl. H04K 1/00

(52) U.S. Cl. 713/185; 380/249

(57) ABSTRACT

A user authentication method is provided which can provide high levels of security without a need for installing any special apparatus on a user side to provide a service to a user over a network.

A numeric value randomly produced by a service providing site is transmitted to a user terminal and a calculation result obtained by applying the numeric value to a numerical calculation method memorized by the user is returned back to the service providing site. The service providing site judges whether the calculation result is right or wrong to perform a user authentication. There is no need for installing any additional device on the service providing site. Information used for the user authentication is not broken, thus avoiding abuse of information for user authentication.

### BACKGROUND OF THE INVENTION

1. Field of the Invention

The present invention relates to user authentication and more particularly to a user authentication method that can be suitably used in checking whether a user is qualified for using a service, for example, the service provided by a company to the user through a network such as the Internet, a network to be used for the user authentication method and a storage medium storing a control program of the same.

The present application claims priority of Japanese Patent Application No. 2000-134054 filed on May 2, 2000, which is hereby incorporated by reference.

2. Description of the Related Art Companies providing distribution services including an information providing service to users through a network such as the Internet, when checking whether the user is qualified for using the service, uses, generally and widely, a user authentication method by using a password that no one except the user in person can know. In the user authentication method using the password, after the user inputs a password to a user terminal, whether the input password matches a password that has been already registered on a system of the company or not is checked. Moreover, in areas where services requiring very high levels of security are provided, a one time password that can be used only one time or a smart card storing information about the user authentication is used for the user authentication. In recent years, not only a conventional personal computer but also a portable cellular phone trend to be rapidly becoming a target for such services to be provided through the Internet.

However, a conventional user authentication method has the following problems. That is, in the user authentication method using the password, security of the password is not sufficient, that is, for example, if the information about the password is sent over a network in a text file format, in some cases, there is a risk that the password is broken on the network and is used by stealth. Furthermore, technology in which the password is encrypted and sent over the network is already used, however, a user terminal that can handle the encrypted password is required and, if a user terminal cannot read the encrypted password, the technology cannot actually be used. To incorporate a user authentication method that can provide higher levels of security than the method using the password, it is necessary to additionally install a special user authentication apparatus. For example, in the method using the one time password, since it is necessary that the user terminal is so configured that same password information is not allowed to flow not less than two times over a same network. The user terminal configured in a manner other than this cannot be used. Moreover, in the method using the smart card, a reading/writing apparatus for exclusive use in the smart card on the user side is required.

Since the user authentication method is developed provided that the user inputs the password by using the personal computer, this method is not applied to a case where the user uses, for example, a portable cellular phone or a like. In the user authentication in a case when the user uses the portable cellular phone, there is a problem in its operability. That is, since most portable cellular phones of small sizes have not full-key including character keys such as alphabet keys or a like, they need complex operations in order to input more secure password including characters. Moreover, when the password is made up of only numeric values, since the password can be easily broken and used by stealth, there is another problem in that the password cannot be easily used.

### SUMMARY OF THE INVENTION

In view of the above, it is an object of the present invention to provide a user authentication method capable of providing high levels of security without a need for installing any special apparatus on a user side, a network system using the user authentication method and a storage medium storing a control program of the network system using the above method.

According to a first aspect of the present invention, there is provided a user authentication method for checking whether a user is qualified for using a service provided through a network, including:

a step of registration of user authentication information to register a numerical calculation method designated by the user and being specific to the user as user authentication information together with user identification information corresponding to the user; and

a step of judging, when the user identification information is transmitted from the user through a network to a service providing site and an arbitrary numeric value is transmitted from the service providing site through the network to the user, whether a first calculation result obtained by using the arbitrary numeric value which has been transmitted from the user through the network to the service providing site agrees with a second calculation result obtained by applying the arbitrary numeric value to the registered numerical calculation method to perform user authentication.

According to a second aspect of the present invention, there is provided a user authentication method for checking whether a user is qualified for using a service provided through a network, including:

a step of registration of user authentication information to register a numerical calculation method designated by the user through the network and being specific to the user as user authentication information together with user identification information corresponding to the user; and

a step of judging, when the user identification information is transmitted from the user through the network to a service providing site and an arbitrary numeric value is transmitted from the service providing site through the network to the user and a first calculation result corresponding to the arbitrary numeric value is transmitted from the user through the network to the service providing site, whether the first calculation result agrees with a second calculation result obtained by applying the arbitrary numeric value to the registered calculation method to perform the user authentication.

According to a third aspect of the present invention, there is provided a network system including:

one or a plurality of user terminals by which a user transmits a numerical calculation method being specific to the user together with user identification information corresponding to the user through a network to a service providing site and transmits a first calculation result obtained by applying a given numeric value to the numeric calculation method through the network to the service providing site;

one or a plurality of service providing sites to register the numerical calculation method together with user identification information corresponding to the user, to transmit an arbitrary numeric value through the network to the user terminal when the user identification information is transmitted from the user terminal through the network and to judge, when the first calculation result corresponding to the arbitrary numeric value is transmitted from the user terminal through the network, whether the first calculation result agrees with a second calculation result obtained by applying the arbitrary numeric value to the registered numerical calculation method to perform the user authentication.

In the foregoing, a preferable mode is one wherein the user terminal has a function of displaying the arbitrary numeric value transmitted from the service providing site.

Also, a preferable mode is one wherein the user terminal has a function of outputting, by voice, the arbitrary numeric value transmitted from the service providing site.

Also, a preferable mode is one wherein the user terminal is made up of a portable cellular phone or a personal digital assistant (PDA), having a function of displaying the arbitrary numeric value transmitted from the service providing site.

Also, a preferable mode is one wherein the user terminal is made up of a portable cellular phone or a PDA, having a function of outputting, by voice, the arbitrary numeric value transmitted from the service providing site.

Also, a preferable mode is one wherein the first calculation result is input by voice of the user to the user terminal and is transmitted through the network to the service providing site and wherein the service providing site has a function of performing voice recognition of the first calculation result.

According to a fourth aspect of the present invention, there is provided a control program to have a computer carry out a user authentication method for checking whether a user is qualified for using a service provided through a network, the method including:

a step of registration of user authentication information to register a numerical calculation method designated by the user and being specific to the user as the user authentication information together with user identification information corresponding to the user; and

a step of judging, when the user identification information is transmitted from the user through the network to a service providing site and an arbitrary numeric value is transmitted from the service providing site through the network to the user, whether a first calculation result obtained by using the arbitrary numeric value which has been transmitted from the user through the network to the service providing site agrees with a second calculation result obtained by applying the arbitrary numeric value to the registered numerical calculation method to perform user authentication.

According to a fifth aspect of the present invention, there is provided a storage medium storing a control program to have a computer carry out a user authentication method for checking whether a user is qualified for using a service provided through a network, the method including:

a step of registration of user authentication information to register a numerical calculation method designated by the user through the network and being specific to the user as the user authentication information together with user identification information corresponding to the user; and

a step of judging, when the user identification information is transmitted from the user through the network to a service providing site and an arbitrary numeric value is transmitted from the service providing site through the network to the user and a first calculation result corresponding to the arbitrary numeric value is transmitted from the user through the network to the service providing site, whether the first calculation result agrees with a second calculation result obtained by applying the arbitrary numeric value to the registered numerical calculation method to perform the user authentication.

According to a sixth aspect of the present invention, there is provided a storage medium storing a control program to have a computer carry out a network system including:

one or a plurality of user terminals by which a user transmits a numerical calculation method being specific to the user together with user identification information corresponding to the user through a network to a service providing site and transmits a first calculation result obtained by applying a given numeric value to the numerical calculation method through the network to the service providing site;

one or a plurality of service providing sites to register the numerical calculation method together with the user identification information corresponding to the user, to transmit an arbitrary numeric value through the network to the user terminal when the user identification information is transmitted from the user terminal through the network and to judge, when the first calculation result corresponding to the arbitrary numeric value is transmitted from the user terminal through the network, whether the first calculation result agrees with a second calculation result obtained by applying the arbitrary numeric value to the registered numerical calculation method to perform the user authentication.

With above configurations, the calculation result obtained by the numerical calculation method designated by users, instead of the password, is used as the method for the user authentication and therefore there is no need for installing specific devices, thus achieving accurate user authentication. Especially, in the service in which a portable cellular phone or PDA is used as the user terminal, since types of the user terminal are various and the number of the user terminals is tremendous, the merit of the present invention is great. Moreover, since the user authentication of the present invention is achieved by transmitting numeric values arbitrarily produced by the service providing site and by the calculation result obtained by applying the transmitted numeric value to the numerical calculation method memorized by the user is returned back to the service providing site and since the numeric value and calculation result passing over the network between the user terminal and the service providing site are valid only when they pass once through the network, no abuse of the information passing over the network can occur. The numerical calculation method employed in this method is one that can be easily memorized as in a case of the conventional password, neither specific storage devices nor specific calculation devices are required on the user terminal side. The numeric value and calculation result are used for the user authentication and, therefore, even in a case of the portable cellular phone where its manipulation on a screen is not easy, the user authentication can be achieved by manipulation which is simpler than by the password. This enables some of a load to be taken off the user and the number of the users using the service to be increased. Since, in the service through the portable cellular phones which are springing into wide use, in particular, the user authentication can be implemented, without impairing security against use by stealth, by the manipulation which is easier compared with the conventional case.

### BRIEF DESCRIPTION OF THE DRAWINGS

The above and other objects, advantages and features of the present invention will be more apparent from the following description taken in conjunction with the accompanying drawings in which:

FIG. 1 is a block diagram showing configurations of a network system to implement a user authentication method according to an embodiment of the present invention;

FIG. 2 is a sequence diagram explaining processing of registering user authentication information employed in the embodiment of the present invention;

FIG. 3 is a diagram showing one example of a screen used to designate a numerical calculation method used for the user authentication employed in the embodiment of the present invention;

FIG. 4 is a diagram showing one example of combinations of a user ID with the numerical calculation method employed in the embodiment of the present invention FIG. 5 is a sequence diagram showing processing of the user authentication employed in the embodiment of the present invention; and

FIG. 6 is a diagram showing one example of a screen used to input a first calculation result corresponding to an arbitrary numeric value employed in the embodiment of the present invention.

### DETAILED DESCRIPTION OF THE PREFERRED EMBODIMENTS

Best modes of carrying out the present invention will be described in further detail using various embodiments with reference to the accompanying drawings.

### First Embodiment

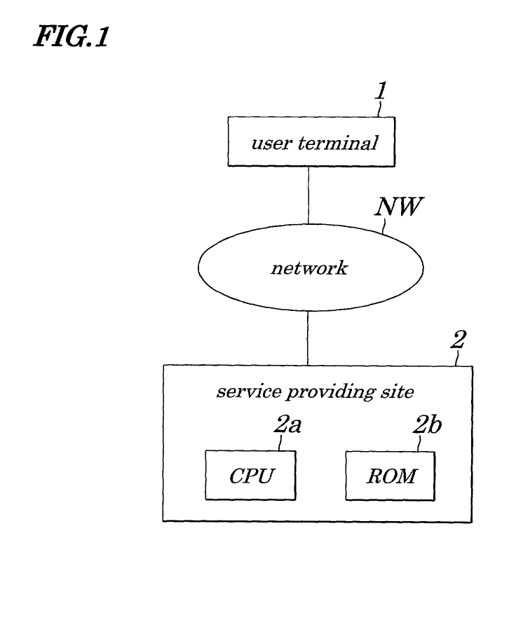

FIG. 1 is a block diagram showing configurations of a network system to implement a user authentication method according to an embodiment of the present invention. As shown in FIG. 1, the network system of the embodiment is made up of one or a plurality of user terminals 1, one or a plurality of service providing sites 2, which are connected together through a network NW such as the Internet. The user terminal 1 is made up of, for example, a portable cellular phone by which a user sends out a numerical calculation method which is specific to the user, together with user identification information (hereinafter referred to as a“user ID” ) corresponding to the user to the service providing site 2 through the network NW and also sends out a first calculation result obtained by applying a given numeric value to the above numerical calculation method to the service providing site 2 through the network NW.

The service providing site 2 is made up of, for example, information processing devices such as a work station, server, or a like, which are adapted to provide a distribution service including an information providing service to the user and has a CPU (Central Processing Unit) 2a used to control the entire service providing site 2 and a storage medium, such as a ROM (Read Only Memory) 2b storing a control program used to operate the CPU 2a. The service providing site 2 registers the numerical calculation method designated by the user, together with the user ID corresponding to the user, as the user authentication information. Moreover, the service providing site 2, when the user ID is transmitted through the network NW from the user terminal 1, transmits an arbitrary numeric value through the network NW to the user terminal 1 and, when a first calculation result corresponding to the arbitrary numeric value is transmitted from the user terminal 1 through the network NW, judges whether the first calculation result agrees with a second calculation result obtained by applying the arbitrary numeric value to the registered numerical calculation method and performs the user authentication based on a judgement result. Furthermore, the service providing site 2, when the first calculation result is input to the user terminal 1 by voice of the user and is transmitted to the service providing site 2, has a function of recognizing the first calculation result by voice.

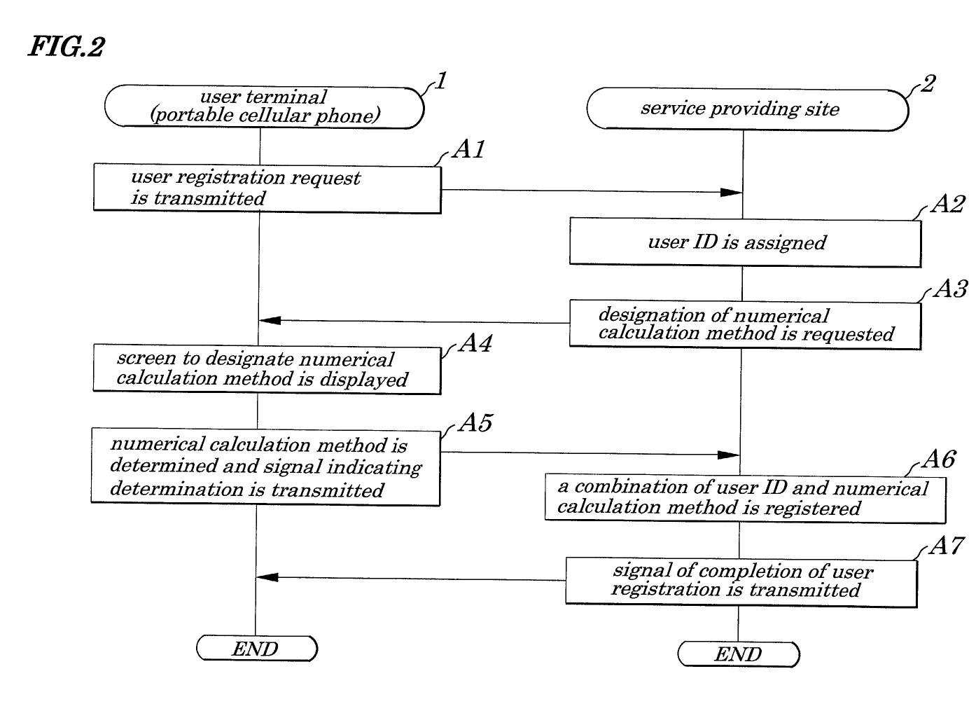

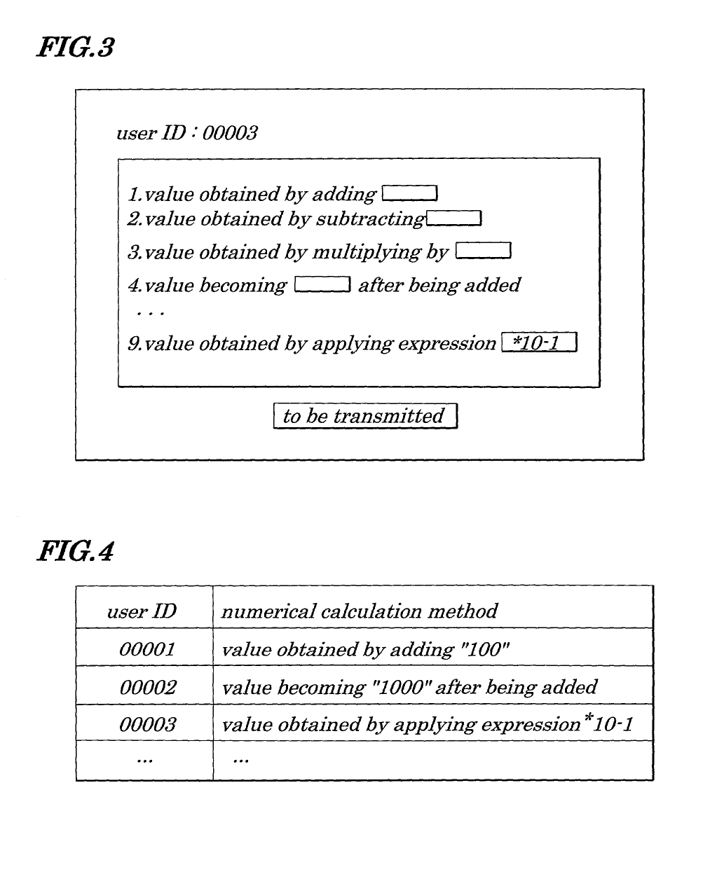

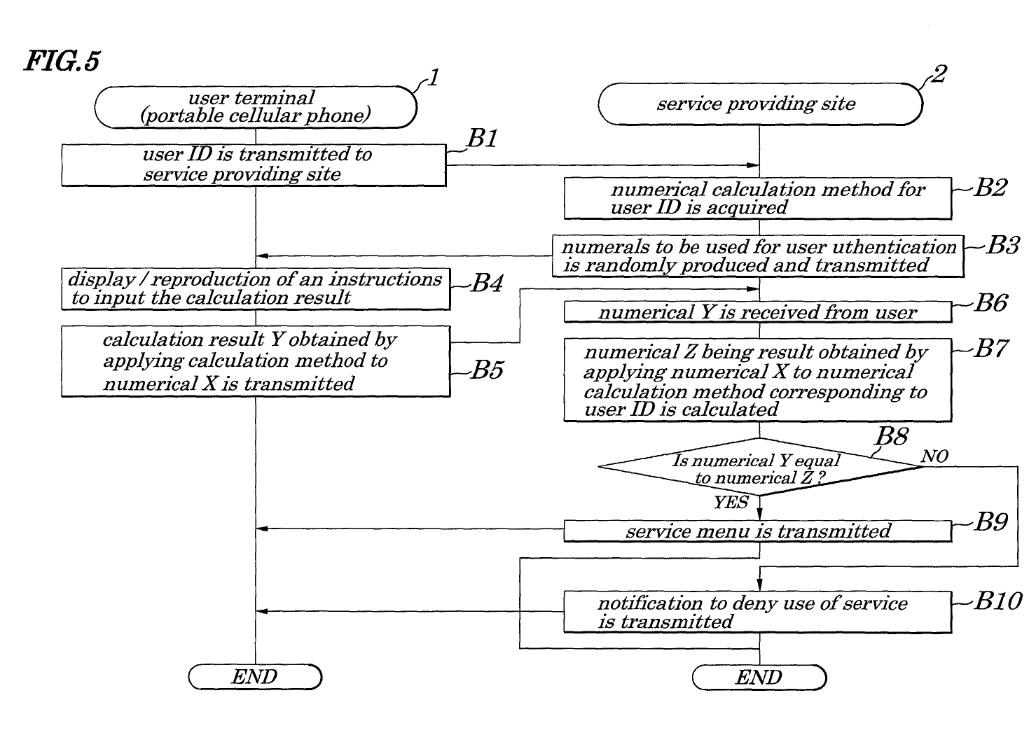

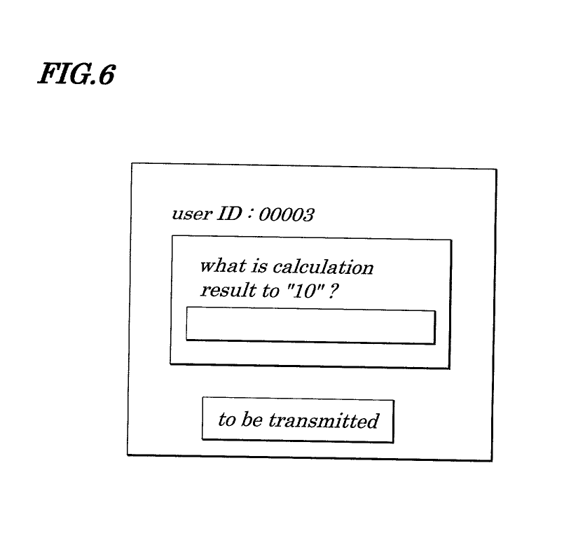

FIG. 2 is a sequence diagram explaining processing of registering user authentication information employed in the embodiment of the present invention. FIG. 3 is a diagram showing one example of a screen used to designate the numerical calculation method used for user authentication employed in the embodiment. FIG. 4 is a diagram showing one example of combinations of the user ID with the numerical calculation method employed in the embodiment. FIG. 5 is a sequence diagram showing processing of the user authentication employed in the embodiment. FIG. 6 is a diagram showing one example of a screen used to input the first calculation result corresponding to the arbitrary numeric value employed in the embodiment.

The user authentication method of the embodiment will be described by referring to FIG. 2 to FIG. 6.

(1) Processing of registering user authentication information is described below.

As shown in FIG. 2, the user, in order to use a distribution service such as an information providing service set up by the service providing site 2 on the network NW, transmits a signal of a request for user registration from the user terminal (portable cellular phone) 1 to the service providing site 2 (Step A1). The service providing site 2, in response to the request for the user registration, assigns the user ID used to uniquely identify a user to the user (Step A2). The service providing site 20, after having assigned the user ID to the user, transmits a screen used to designate the numerical calculation method to be used for the user authentication to the user terminal (portable cellular phone) 1 (Step A3). As shown in FIG. 3, the screen used to designate the numerical calculation method to be used for the user authentication is displayed on the user terminal (portable cellular phone) 1 (Step A3). The user designates the numerical calculation method to be used for the authentication of the user by using the screen displayed on the user terminal (portable cellular phone) 1 and transmits a signal indicating the method to the service providing site 2 (Step A4). As the numerical calculation method, the method using an expression “*10-1” (shown in FIG. 3) is designated and the numerical calculation method is used for the user authentication. In this case, the user has to accurately memorize the numerical calculation method designated at a time of the user registration, however, the numerical calculation method is so configured that it can be easily memorized, as in a case of a conventional password. The numerical calculating method to be used for the user authentication is transmitted from the user terminal (portable cellular phone) 1 (Step A5) and the service providing site 2 registers a combination of the numerical calculating method with the user ID (Step A6). The service providing site 2, when the registration of the user authentication information is completed, a notification of the completion of the registration is transmitted to the user terminal (portable cellular phone) 1 (Step A7).

(2) Processing of user authentication is described below.

When the user having already registered the user authentication information uses the above service, as shown in FIG. 5, the user, in order to use the service set up by the service providing site 2 over the network NW, operates a key of the user terminal (portable cellular phone) 1 to transmit the user ID to the service providing site 2 through the network NW (Step B1). If the service providing site 2 is provided with a voice recognition function, the user ID can be transmitted by voice from the user terminal (portable cellular phone) 1. The service providing site 2 receives the user ID, retrieves the user authentication information based on the user ID and acquires the information about the numerical calculation method for the user authentication which has been stored to correspond to the user ID (Step B2).

The service providing site 2 randomly produces a numeric value X to be used for the user authentication and transmits the produced numeric value to the user terminal (portable cellular phone) 1 (Step B3). A screen used to give instructions to inputting of calculation results obtained by applying the numeric value X (for example, X=10) to the numerical calculation method designated at the time of the user registration is displayed in the user terminal (portable cellular phone) 1, as shown in FIG. 6 (Step B4). The user, by using the screen, inputs a calculation result Y obtained by applying the numerical calculation method designated at the time of registration of the user authentication information to the numeric value X transmitted from the service providing site 2 to the user terminal (portable cellular phone) 1 to transmit it to the service providing site 2 (Step B5). In the screen in FIG. 6, “00003” is displayed as the user ID and “10” is displayed as the numeric value X transmitted from the service providing site 2.

In the numerical calculation method designated at the time of the registration of the user authentication information for the user (user ID: “00003”), an expression “*10-1” shown in FIG. 4 is used. If the user correctly memorizes the numerical calculation method designated at the time of the registration of the user authentication, the expression “*10-1” shown in FIG. 4 as the method for the numerical calculation method is applied to a numeric value x “10”transmitted from the service providing site 2 and “99” as a calculation result Y can be obtained. The user, by inputting “99” as the calculation result Y to the screen as shown in FIG. 6 and by transmitting it to the service providing site 2, certifies its own identity in the service providing site 2. In Step B4, when the service providing site 2 is provided with a voice recognition function, the screen as shown in FIG. 6 is not displayed and an instruction to input the calculation result by voice is reproduced in the user terminal (portable cellular phone) 1 and, in Step B5, the inputting of the calculation result by the user is performed by inputting the voice to the user terminal (portable cellular phone) 1.

The service providing site 2 receives the calculation result obtained by using the numeric value X for the user authentication from the user terminal (portable cellular phone) 1 (Step B6). Then, the service providing site 2, by applying the numerical calculation method stored by the service providing site 2 in a manner that it corresponds the user ID to the numeric value X produced in Step B3, acquires a numeric value Z as the calculation result (Step B7). In the examples shown in FIG. 4 and FIG. 6, the user ID is “00003”, the numeric value X is “10” and the numeric value calculation method uses the expression “*10-1” shown in FIG. 4, the service providing site 2 can obtain “99” as the numeric value Z being the calculation result. The service providing site 2 compares the calculation result Y received from the user terminal 1 in Step B6 with the numeric value Z obtained by the calculation in Step B7 (Step B8). As a result, if the calculation result Y turns out to be equal to the numeric value Z, the service providing site 2 recognizes the user who has transmitted the user ID “00003” as an authorized user and transmits a service menu to the user terminal 1 (Step B9).

In Step B8, if the calculation result Y is not equal to the numeric value Z, the service providing site 2 does not recognize the user who has transmitted the user ID “00003” as the authorized user and transmits a notification that it denies use of service by the user (Step B10). In the examples in FIG. 6 and 4, if the user has transmitted “99” as the calculation result Y, the service providing site 2 recognizes the user as the authorized user and transmits the service menu and if the user has transmitted any numeric value other than “99”, the service providing site 2 denies the use of the service by the user.

Thus, according to the embodiment, instead of the user authentication using the conventional password, the user authentication method in which the calculation result Y obtained by the numerical calculation method designated by the user is confirmed, is employed, an accurate user authentication is made possible without incorporating a specific device in the user terminal (portable cellular phone) 1. Especially, in the service in which a portable cellular phone or a personal digital assistant (PDA), which is springing into wide use, is used as the user terminal 1, since types of service terminals are various and the number of the user terminals shipped is tremendous, the present invention can provide a great merit.

Moreover, in the user authentication of the present invention, the numeric value X produced randomly by the service providing site 2 is transmitted to the user terminal 1 and the numerical calculation method memorized by the user is applied to the calculation result Y and the calculation result Y is sent back to the service providing site 2 and, since the numeric value X and calculation result Y passing over the network NW between the user terminal 1 and the service providing site 2 is valid only when it passes once, neither breaking of the information nor abuse of the information passing over the network NW occur. Furthermore, since the numeric value calculation method is one that can be memorized easily by the user as in the case of the conventional password, there is no need for installing specific storage devices or calculation devices on the user terminal 1. Also, since the numeric value X and calculation result Y are used for the user authentication, even in the case of the portable cellular phone where its manipulation on the screen is not easy, the user authentication can be achieved by the manipulation which is simpler than by the password. This enables some of a load to be taken off the user and the number of the users to be increased. Since, in service through the portable cellular phones, which are springing into wide use, the user authentication can be implemented, without impairing security against use by stealth, by the manipulation which is easier compared with the conventional case, the present invention can provide a great merit.

It is apparent that the present invention is not limited to the above embodiments but may be changed and modified without departing from the scope and spirit of the invention. For example, as the user terminal 1, in addition to portable cellular phones, the PDA, personal computer or a like may be used as well. Information provided as a distribution service from the service providing site 2 may includes music data, and image data (such as a movie, photo, painting, or a like). In this case, the user terminal 1 has to be configured so as to have a function of reproducing the information. Moreover, the information provided as the distribution service from the service providing site 2 may be arbitrary information so long as the information can be distributed over the network NW such as the Internet.

What is claimed is:

1. A user authentication method for checking whether a user is qualified for using a service provided through a network, comprising:
a step of registration of user authentication information to register a numerical calculation method designated by said user and being specific to said user as said user authentication information together with user identification information corresponding to said user; and
a step of judging, when said user identification information is transmitted from said user through said network to a service providing site and an arbitrary numeric value is transmitted from said service providing site through said network to said user, whether a first calculation result obtained by using said arbitrary numeric value which has been transmitted from said user through said network to said service providing site agrees with a second calculation result obtained by applying said arbitrary numeric value to said registered numerical calculation method to perform user authentication.

2. A user authentication method for checking whether a user is qualified for using a service provided through a network, comprising:
a step of registration of user authentication information to register a numerical calculation method designated by said user through said network and being specific to said user as said user authentication information together with user identification information corresponding to said user; and
a step of judging, when said user identification information is transmitted from said user through said network to a service providing site and an arbitrary numeric value is transmitted from said service providing site through said network to said user and a first calculation result corresponding to said arbitrary numeric value is transmitted from said user through said network to said service providing site, whether said first calculation result agrees with a second calculation result obtained by applying said arbitrary numeric value to said registered numerical calculation method to perform said user authentication.

3. A network system comprising:
one or a plurality of user terminals by which a user transmits a numerical calculation method being specific to said user together with user identification information corresponding to said user through a network to a service providing site and transmits a first calculation result obtained by applying a given numeric value to said numerical calculation method through said network to said service providing site;
one or a plurality of service providing sites to register said numerical calculation method together with said user identification information corresponding to said user, to transmit an arbitrary numeric value through said network to said user terminal when said user identification information is transmitted from said user terminal through said network and to judge, when said first calculation result corresponding to said arbitrary numeric value is transmitted from said user terminal through said network, whether said first calculation result agrees with a second calculation result obtained by applying said arbitrary numeric value to said registered numerical calculation method to perform said user authentication.

4. The network system according to claim 3, wherein said user terminal has a function of displaying said arbitrary numeric value transmitted from said service providing site.

5. The network system according to claim 3, wherein said user terminal has a function of outputting, by voice, said arbitrary numeric value transmitted from said service providing site.

6. The network system according to claim 3, wherein said user terminal is made up of a portable cellular phone or a personal digital assistant, having a function of displaying said arbitrary numeric value transmitted from said service providing site.

7. The network system according to claim 3, wherein said user terminal is made up of a portable cellular phone or a personal digital assistant, having a function of outputting, by voice, said arbitrary numeric value transmitted from said service providing site.

8. The network system according to claim 3, wherein said first calculation result is input by voice of said user to said user terminal and is transmitted through said network to said service providing site and wherein said service providing site has a function of performing voice recognition of said first calculation result.

9. A storage medium storing a control program to have a computer carry out a user authentication method for checking whether a user is qualified for using a service provided through a network, said method comprising:
a step of registration of user authentication information to register a numerical calculation method designated by said user and being specific to said user as said user authentication information together with user identification information corresponding to said user; and
a step of judging, when said user identification information is transmitted from said user through said network to a service providing site and an arbitrary numeric value is transmitted from said service providing site through said network to said user, whether a first calculation result obtained by using said arbitrary numeric value which has been transmitted from said user through said network to said service providing site agrees with a second calculation result obtained by applying said arbitrary numeric value to said registered numerical calculation method to perform user authentication.

10. A storage medium storing a control program to have a computer carry out a user authentication method for checking whether a user is qualified for using a service provided through a network, said method comprising:
a step of registration of user authentication information to register a numerical calculation method designated by said user through said network and being specific to said user as said user authentication information together with user identification information corresponding to said user; and
a step of judging, when said user identification information is transmitted from said user through said network to a service providing site and an arbitrary numeric value is transmitted from said service providing site through said network to said user and a first calculation result corresponding to said arbitrary numeric value is transmitted from said user through said network to said service providing site, whether said first calculation result agrees with a second calculation result obtained by applying said arbitrary numeric value to said registered numerical calculation method to perform said user authentication.

11. A storage medium storing a control program to have a computer carry out a network system comprising:
one or a plurality of user terminals by which a user transmits a numerical calculation method being specific to said user together with user identification information corresponding to said user through a network to a service providing site and transmits a first calculation result obtained by applying a given numeric value to said numerical calculation method through said network to said service providing site;
one or a plurality of service providing sites to register said numerical calculation method together with said user identification information corresponding to said user, to transmit an arbitrary numeric value through said network to said user terminal when said user identification information is transmitted from said user terminal through said network and to judge, when said first calculation result corresponding to said arbitrary numeric value is transmitted from said user terminal through said network, whether said first calculation result agrees with a second calculation result obtained by applying said arbitrary numeric value to said registered numerical calculation method to perform said user authentication.
